(19) United States
(12) Patent Application Publication
(10) Pub. No.: US 2004/0113863 A1
(43) Pub. Date: Jun. 17, 2004

(54) Microwave frequency antenna reflector

(76) Inventor: Roger A. Stonier, La Selva Beach, CA (US)

Correspondence Address: J. E. Kosinski, Loral Space & Communications, Ltd., Suite 303, 655 Deep Valley Drive, Rolling Hills Estates, CA, 90274, US

(21) Appl. No.: 10/320,076

(22) Filed: Dec. 16, 2002

(51) Int. Cl. H01Q 1/36; H01Q 15/14; H01Q 15/20

(52) U.S. Cl. 343/897; 343/915

(57) ABSTRACT

An antenna reflector for a spacecraft. The antenna reflector comprises one outer layer of an electrically conductive and electrically reflective material including a plurality of openings formed therein. The antenna reflector also comprises at least one inner layer of a fabric material bonded to the outer layer. The fabric material includes a plurality of openings formed therein. The combination of the openings in the outer layer and the openings in the inner layer allow acoustic noise to be transmitted and dissipated through the openings.

### BACKGROUND OF THE INVENTION

1. Field of the Invention

The present invention generally relates to microwave antenna reflector structures for use on spacecraft operating in space, and in particular to an antenna reflector for Ka-Band and higher frequency microwave.

2. Brief Description of Related Developments

Antenna reflectors constructed of tri-axial woven graphite fabric materials perform very well electrically at Ku-Band and lower microwave communications frequencies, such as L-Band, C-Band, S-Band and X-Band frequencies, but do not work well electrically at Ka-Band and higher frequencies. The reason that the tri-axial woven fabric antenna reflectors do not work well at frequencies higher than Ku-Band is because of the types of graphite fibers used in the tri-axial woven graphite fabric materials, their inherent compositions and their corresponding electrical properties. Only certain graphite fibers can be woven into a tri-axial woven fabric material due to the specific physical and mechanical properties of the fibers and constraints imposed by the weaving equipment. Some graphite fiber yarns are not of an acceptable size and some graphite fibers are too brittle and tend to break or are damaged in the special weaving loom used to weave the tri-axial woven fabric material. The graphite fibers that can be utilized in the tri-axial woven fabric do not have very good electrical conductivity or electrical reflectivity properties compared to some other graphite fibers, and particularly when compared to some highly conductive metals like copper, aluminum, silver and gold. At microwave frequencies of Ka-Band and at higher microwave frequencies, the electrical performance characteristics of currently available tri-axial woven fabric materials are not desirable for newer high performance microwave antenna reflectors designed for spacecraft.

The tri-axial woven graphite fabric used in Ku-Band and lower microwave frequency reflectors is generally impregnated with a polymer resin and molded in at least one layer with the tri-axial woven fabric graphite fibers woven along three axis to give the fabric quasi-isotropic properties, i.e., the same strength, stiffness, coefficient of thermal expansion, thermal stability and distortion characteristics in all directions.

U.S. Pat. No. 5,686,930 assigned to the assignee of the present application, the disclosure of which is incorporated herein by reference in its entirety, is directed to an ultra-lightweight antenna reflector that includes a thermally stable single ply, tri-axially woven fabric of graphite fibers. This reflector is space flight qualified and is used on spacecraft at microwave frequencies of Ku-Band and lower microwave frequencies.

Graphite fiber composite antenna reflectors operating at Ka-Band and higher microwave frequencies have been developed, qualified for space and have actually been launched into space on spacecraft. However, these Ka-Band and higher microwave frequency antenna reflectors do not contain tri-axial woven fabric materials. This is because the tri-axial woven fabric material does not provide acceptable microwave reflectivity from the reflector surface. Rather, these Ka-Band and higher frequency graphite reflectors consist of either a stiffened solid laminate construction or a honeycomb sandwich structure with generally solid graphite composite skins. The solid graphite composite laminate or skins generally utilize either uni-directional graphite fiber tape or a graphite bi-directional woven fabric, both with a polymer resin matrix material. For the uni-directional tape, the graphite fibers are placed side by side and can be spread to obtain the desired thickness. The fibers are supplied with an uncured polymer resin in a prepreg tape form. Normally multiple tape layers are used to form the laminate in the stiffened laminate construction. The bi-directional woven fabrics are normally plain weaves or 5-harness satin weaves, also impregnated with a polymer resin, and multiple layers are normally used for the laminate. The same materials are used for honeycomb sandwich skins. The skins are usually thinner and have fewer layers. The polymer resin is cured at an elevated temperature to rigidize the laminate or skin. U.S. Pat. No. 6,018,328 discloses a single surface of a tri-axial woven fabric material as the laminate or skin. A reflector design using a tri-axial woven fabric material would be preferred for Ka-Band and higher frequency antenna reflectors over unidirectional tapes or bi-directional woven fabrics because of the lower mass that would result and the holes in the laminate or skin would allow acoustic noise energy to be transmitted and dissipated. This is a major deficiency of all prior art reflectors that use unidirectional tapes and bi-directional woven fabrics to form a solid laminate or solid sandwich skin construction. To overcome this deficiency more material is required and this results in more mass. Antenna reflectors, as well as other spacecraft hardware, are normally designed to the lightest mass possible.

### SUMMARY OF THE INVENTION

The present invention is directed to an antenna reflector for a spacecraft. In one embodiment, the antenna reflector comprises at least one outer layer of an electrically conductive and electrically reflective material including a plurality of openings formed therein. The antenna reflector also comprises at least one inner layer of a fabric material bonded to the outer layer. The fabric material includes a plurality of openings formed therein. The combination of the openings in the outer layer and the openings in the inner layer allow acoustic noise to be transmitted and dissipated through the openings.

In one aspect, the present invention is directed to a method of forming a reflector membrane for an antenna reflector for a spacecraft. In one embodiment, the method includes forming at least one outer layer of an electrically conductive and electrically material including a plurality of openings formed therein. An inner layer is formed of a fabric material, the fabric material including a plurality of openings therein. The openings of the outer layer are aligned with the openings of the inner layer to form a plurality of combined openings in the reflector membrane. The combined openings are adapted to allow acoustic noise transmission and dissipation through the combined openings. The antenna reflector is adapted to operate in at least a microwave frequency band. The outer layer is bonded to the inner layer.

In a further aspect, the present invention is directed to an antenna reflector structure for reflecting microwaves emitted and received by a microwave antenna while operating in space. In one embodiment, the antenna reflector structure comprises, in combination, the elements of a first surface microwave reflective mesh layer affixed to a second tri-axial woven fabric structural layer, the second layer having holes formed within the fabric by the intersection of three fibers oriented tri-axially in three directions to one another. The first microwave reflective layer is a mesh having holes or openings that are large enough to allow acoustic noise waves produced during launch of the antenna on a spacecraft into space to be transmitted through the holes in the reflective mesh layer and through the holes that exist in the second tri-axial woven fabric layer. The holes in the first microwave reflective mesh layer are small enough to still reflect the microwaves.

### BRIEF DESCRIPTION OF THE DRAWINGS

The foregoing aspects and other features of the present invention are explained in the following description, taken in connection with the accompanying drawings, wherein:

FIG. 1 is a partial schematic diagram of one embodiment of a spacecraft illustrating a combination of a microwave antenna and a microwave reflector incorporating features of the present invention.

FIG. 2 is a side view of one embodiment of an antenna reflector of the present invention mounted on a support member to be utilized in conjunction with the spacecraft of FIG. 1.

FIG. 3 is a perspective view illustrating one embodiment of the formation of a honeycomb sandwich reflector member of the present invention.

FIG. 3A is a partial cross-sectional view of the honeycomb sandwich reflector of FIG. 3 illustrating the reticulation of the adhesive.

FIG. 4 is a perspective view illustrating one embodiment of a reflector member formed according to FIG. 3.

FIG. 5 is a perspective view of one embodiment of a support member for the antenna reflector of FIG. 2.

FIG. 6 illustrates an exploded view of one embodiment of a tri-axial woven fabric.

FIG. 7 illustrates an exploded view of one embodiment of a multi-axial fabric used in the reflector member of FIG. 2 illustrating the use of a copper foil mesh layer.

FIG. 8 illustrates an exploded view of one embodiment of a multi-axial fabric used in the reflector member of FIG. 2 illustrating the use of another copper foil mesh layer.

FIG. 9 illustrates an exploded view of one embodiment of a multi-axial fabric used in the reflector member of FIG. 2 illustrating the use of an aluminum foil mesh.

FIG. 10 illustrates an exploded view of one embodiment of a multi-axial fabric used in the reflector member of FIG. 2 illustrating the use of an aluminum screen.

FIG. 11 illustrates an exploded view of one embodiment of a multi-axial fabric used in the reflector member of FIG. 2 illustrating the use of a copper screen.

### DETAILED DESCRIPTION OF THE PREFERRED EMBODIMENT(s)

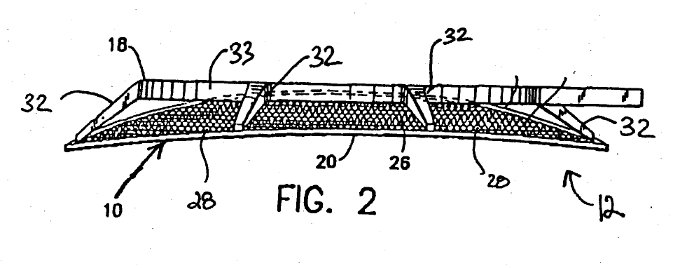

Referring to FIG. 2, one embodiment of a reflector member assembly 10 with a support structure 18 incorporating features of the present invention is illustrated. Although the present invention will be described with reference to the embodiment shown in the drawings, it should be understood that the present invention can be embodied in many alternate forms of embodiments. In addition, any suitable size, shape or type of elements or materials could be used.

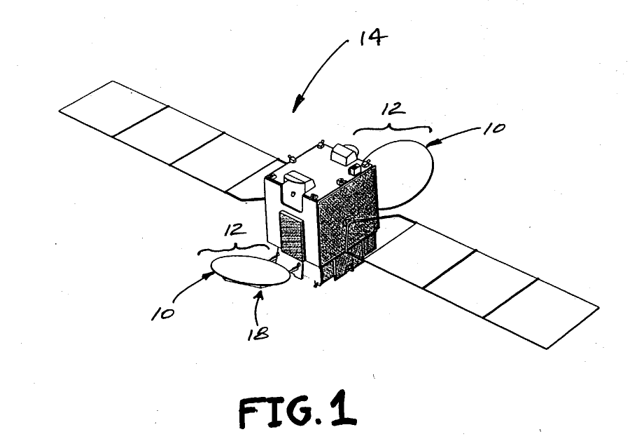

The reflector member assembly 10 with support structure 18 of FIG. 2 is suitable for use with an antenna 12 on a spacecraft, such as a satellite 14, as illustrated in FIG. 1. The illustration of the spacecraft 14 is only a partial illustration, as it will be understood by one of skill in the art that a spacecraft can include other suitable equipment and components, not necessarily shown.

Referring to FIG. 2, the antenna 12, with reflector member assembly 10, is generally adapted to transmit and receive information and signals over microwaves within one frequency band, where the transmit frequency is slightly different than the receiving signal frequency. In one embodiment, the antenna 12 and reflector member assembly 10 is adapted to operate in the Ka-Band or higher microwave frequencies. In alternate embodiments, the antenna 12 and reflector member assembly 10 can be adapted to operate within any suitable frequency band. It is a feature of the present invention to be able to use the antenna reflector at least for Ka-Band and higher frequencies.

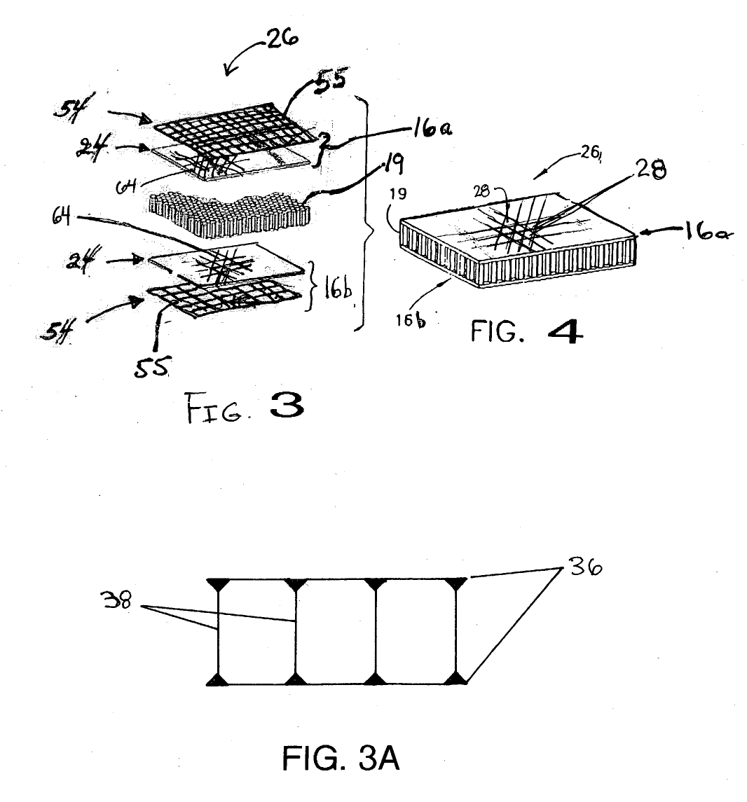

Referring to FIG. 3, the sandwich membrane shell 26 shown in FIG. 2 generally comprises two skins 16 having a single ply microwave reflective layer 54 positioned over a single ply tri-axial woven material or fabric layer 24. The layer 54 includes openings or holes 55 formed therein and the tri-axial fabric layer 24 includes openings or holes 64 formed therein. An example of a single ply tri-axial woven fabric reflector, such as the Ku-Band and lower microwave frequencies antenna reflector is illustrated in U.S. Pat. No. 5,686,930. The combination 16 of layers 54 and 24 forms a sandwich skin that enables the reflector assembly 10 to reflect Ka-Band and higher frequency microwaves and to endure high acoustic noise levels without failing structurally.

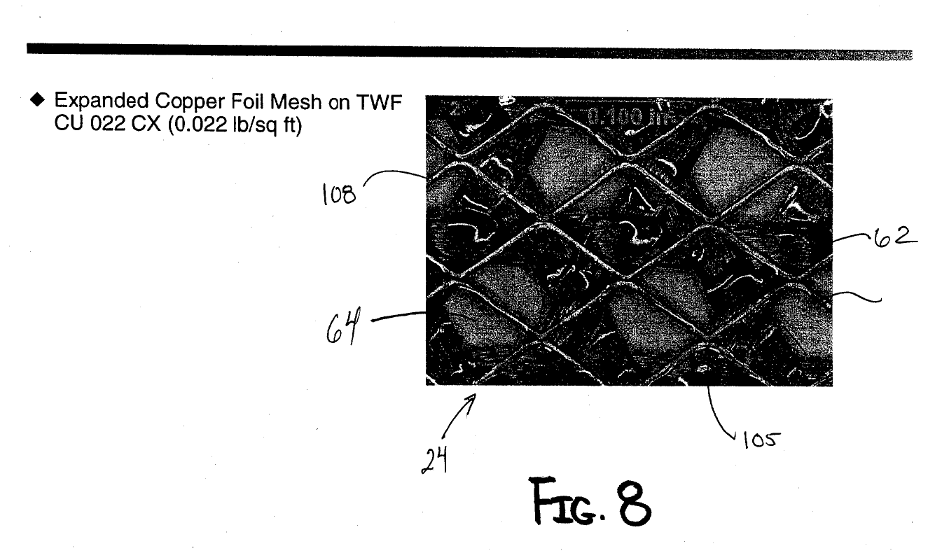

As shown in FIG. 2 and FIG. 3, the sandwich membrane shell 26 includes skins 16 shown in FIG. 4 having a plurality of holes or openings 28 formed in the combined membrane. The openings 28 are generally a combination of the openings in each of the layers 24 and 54 and formed by the positioning of the reflective layer 54 adjacent to or over the layer 24. FIG. 7 illustrates the openings 55 of layer 54 positioned over the openings 64 of layer 24. The shape of the openings 28 is a function of the positioning of the layer 54 with respect to the layer 24.

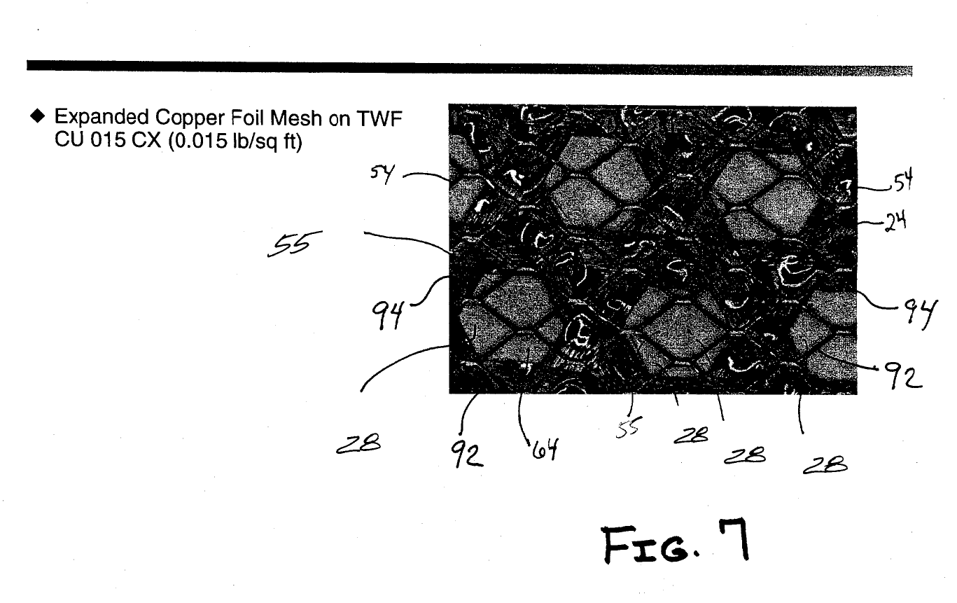

FIG. 6 illustrates an example of a weave pattern of the layer 24. The tri-axial weave pattern of fibers 65, 66 and 67 forms a series of openings 64. The openings 64 in the layer 24 are generally formed by the intersection of the three graphite fibers 65, 66, 67 oriented tri-axially to one another that make up the tri-axial woven fabric material. Although, FIG. 6 illustrates a tri-axial weave fabric, any uniform multi-axial weave may be used. One example of a suitable tri-axial woven fabric material is supplied by SAKASE ADTECH Co., LTD of Shimoyasuda, Maruoka, Fukui, Japan. One tri-axial woven fabric material used is designated SK-906 which contains a graphite fiber manufactured by Nippon Graphite Fiber of Tokyo, Japan, designated YS-50A-15S. In alternate embodiments, other tri-axial woven fabric materials could be used as long as they provide the structural capability and meet all of the other requirements for that particular antenna. The tri-axial woven fabric material is generally combined with a polymer resin material that encapsulates and impregnates the tri-axial woven fabric material to form a tri-axial woven fabric prepreg that is then cured under heat and pressure to form the rigid structure. The openings 64 can have any suitable geometric shape, such as for example, a hexagonal shape as shown in FIG. 6.

As shown in the embodiment of FIG. 7, the reflective layer 54 has openings 55. In this embodiment, the openings are substantially in the shape of a parallelogram, although any suitable geometric shape can be utilized. When the layer 54 is placed over the layer 24 in FIG. 7, a hole or opening pattern 28 results from the alignment of openings 55 over openings 64. The alignment of the outer microwave layer 54 with respect to the tri-axial woven fabric layer 24 does not need to be precise.

Some attempt can be made to align the holes 55 in the first surface mesh 54 with the holes 64 in the tri-axial woven fabric 24. However, even a random placement of the two materials with respect to each other will provide enough open hole areas 28 in the two-layer combined laminate or skin 16 to provide for the desired benefit of acoustic noise transmission and dissipation through the open holes.

The holes or openings 28 shown in FIG. 7 must be large enough to allow acoustic noise, such as that generated by the launch vehicle during the launch of the spacecraft on the space vehicle, to be transmitted and dissipated.

The outer, microwave reflective layer 54 can comprise a trico knit fabric or a woven fabric. In one embodiment the microwave reflective layer 54 can comprise an expanded metal foil mesh. For example, referring to FIG. 7, an expanded copper foil mesh 92 on a tri-axial woven fabric layer 24 is shown. In this embodiment, the copper foil mesh comprises a CU 015 CX (0.015 lb/sq. ft.) mesh. In alternate embodiments any suitable mesh and mesh size could be used, such as for example a CU 022 CX (0.022 lb/sq. ft.) mesh 108 with openings 105 as shown in FIG. 8. Other examples of alternate mesh materials include a woven wire fabric layer or a metal knit layer.

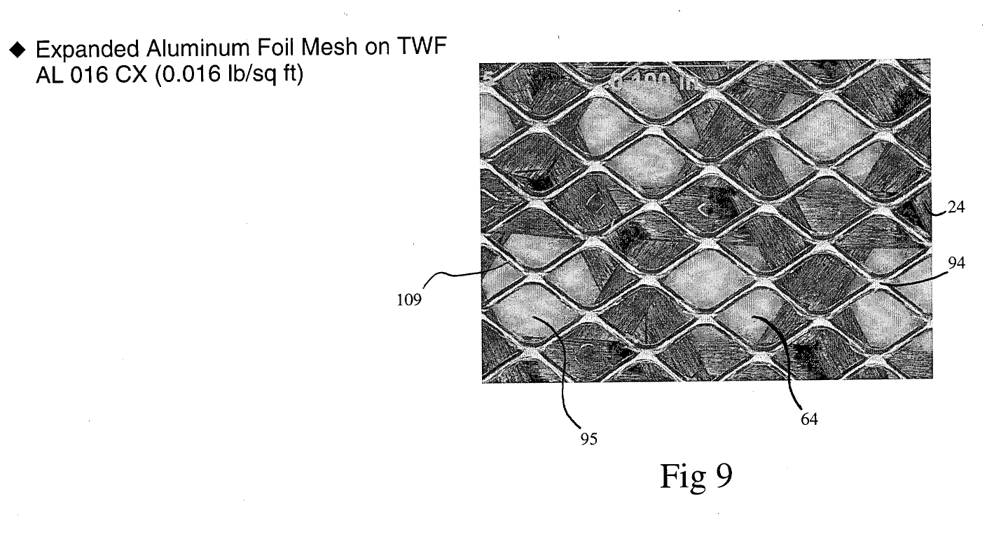

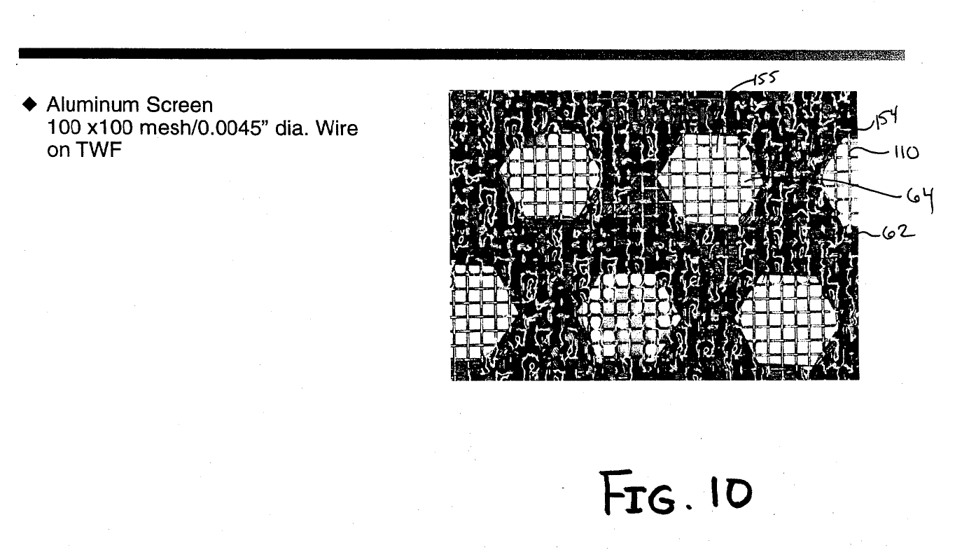

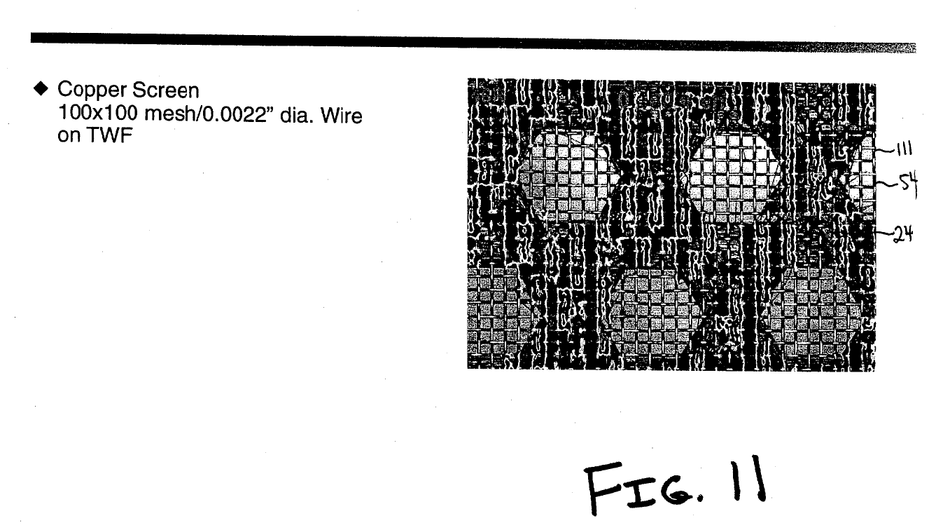

The woven fabric layer could also include aluminum or copper wires or wires of other materials. The expanded metal foil layer could include aluminum or copper. For example, an expanded aluminum foil mesh 109 as the reflective layer 94 with openings 95 over the tri-axial woven fabric layer 24 could be used as shown in FIG. 9. Another example of a material for a reflective layer 154 would be an aluminum screen 110 (mesh/0.0045 inch diameter wire) with openings 155 on the tri-axial woven fabric layer 24 as shown in FIG. 10. Alternatively, a copper screen 111 (100×100 mesh/0.0022 inch diameter wire) on the tri-axial woven fabric layer 24 can be utilized as shown in FIG. 11. The materials and respective dimensions described herein are merely exemplary, and any suitable material of suitable dimensions can be used.

Generally, the wires or metal elements making up the layer 54 are much smaller in diameter than the fibers of the tri-axial woven fabric material of layer 24. In one embodiment, the layer 54 could include an unwoven fiber, such as a conductive plastic fiber material. For example, a conductive plastic fiber material could be used to form a knitted fabric mesh that could comprise the layer 54. The microwave reflective layer 54 could also be used with a layer 24 formed of a tri-axial woven fabric that is not graphite. Examples of these tri-axial woven fabric materials can include aramid, PBO, fiberglass and quartz glass. Graphite fibers are used in the tri-axial woven fabric for antenna applications because they reflect microwave signals at Ku-Band and lower frequencies. However, the addition of the outer microwave layer 54 allows the reflector assembly 10 to utilize a dielectric tri-axial woven fabric or a bi-directional woven fabric material.

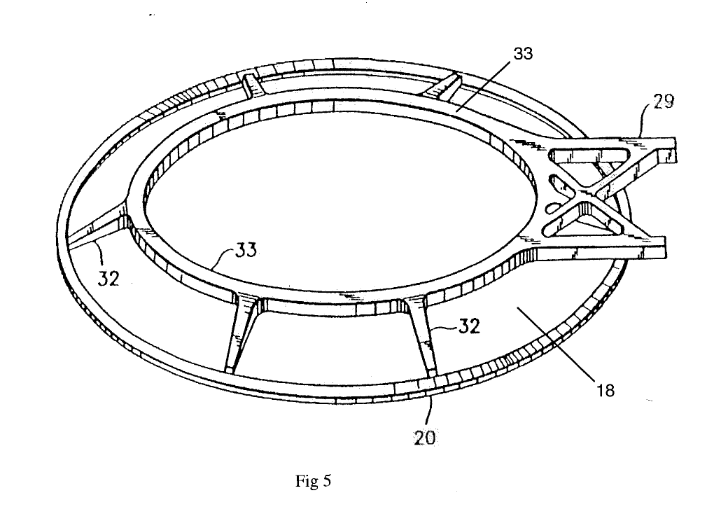

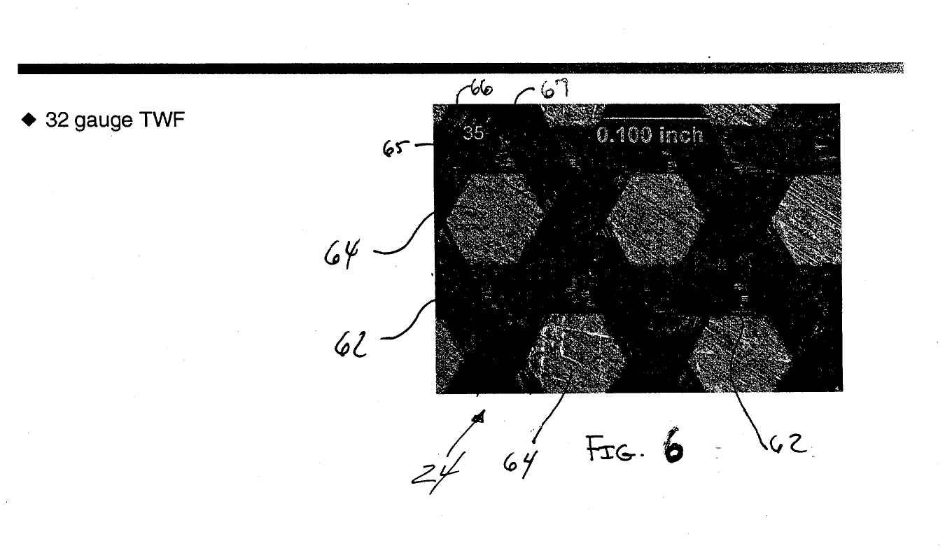

As shown in FIGS. 2 and 3 the reflector assembly 10 generally comprises a sandwich membrane shell 26, which comprises skins 16 each having a multi-axially woven fabric 24 and a microwave reflective layer 54. The shape of the reflector 10 can be any suitable geometric shape, including for example, planar, parabolic or hyperbolic. The reflector assembly 10 also includes a support 18 including an outer peripheral reflector ring 20 and a rear back-up or support frame portion 22 as shown in FIGS. 2 and 5. The support 18 comprises an inner stiffening ring 33 and rear back-up axial support frame portions 32. A plurality of the axial support frame member portions 32 are attached to and supported by the inner stiffening ring 33 and outer peripheral ring 20. In one embodiment at least six axial support frame members are used, although in alternate embodiments any suitable number may be used.

As shown in FIG. 2, the reflector sandwich membrane shell 26 is attached and supported by spaced areas off of the inner ring 33 and outer ring 20 of support structure 18, i.e., only at discrete flexure attachment points. The support structure 18 may be molded from unidirectional composite tape and woven fabric formed preferably from graphite or other high modulus fiber impregnated with a curable resin composition that results in a composite having a high modulus and low coefficient of thermal expansion. Such materials and manufacturing techniques may also be applied to mold the inner ring 33, outer ring 20 and support members 32. The inner ring portion 33 is formed from a minimal number of tubular integrated parts and is designed for a minimum weight. Multi-layer insulation may also be applied to protect all or part of the reflector support structure 18 from the thermal environments experienced in orbit. The reflector sandwich membrane shell 26 would not be covered with multi-layer insulation to allow for acoustic noise to penetrate through the membrane shell. The outer ring 20 and support members 32 may be constructed of a sandwich with a honeycomb core and would then be attached to the reflector sandwich membrane shell 26 by clips bonded with a polymer adhesive to both the sandwich membrane shell 26 and to the ring 20 or support members 32.

Referring to FIG. 3, one embodiment of the formation of the sandwich membrane shell 26 of the reflector member assembly 10 is illustrated. Generally, the sandwich membrane shell 26 comprises a honeycomb sandwich structure that includes a first layer 54 along with a second layer 24 on a front skin of the sandwich structure. The same assembly is shown on the back side of the honeycomb structure to provide symmetry and balance for dimensional stability. The conductive mesh layer 54 is electrically conductive and electrically reflective and includes holes or openings 55 formed therein. The layer 54 is attached to a layer 24 that comprises a structural tri-axial woven fabric layer having holes or openings 64 formed therein. The layer 54 can be attached to the layer 24 by any suitable method, including bonding or molding for example.

Referring to FIGS. 3 and 4, the reflector sandwich membrane shell member 26 is formed by laminating the conductive mesh layer 54 to the multi-axially woven triax fabric layer 24 and bonding these two combined elements of a sandwich skin 16 to a central reinforcing core material 19 of conventional honeycomb material, such as graphite aramid or PBO fiber reinforced plastic, aramid paper, or aluminum alloy, for example. The materials can be bonded using any suitable materials, such as for example a curable adhesive layer 17 on both sides of the central reinforcing core 19. The adhesive can be applied to the edges of the cell walls of the honeycomb core. This can be referred to as reticulation of the adhesive. In this manner the adhesive does not plug up the holes in the two layers with resin and does not cover or seal the larger holes in the core cells. One embodiment of this is illustrated in FIG. 3A where a partial cross-section of the structure 26 is shown with the reticulated adhesive 36 along the edges of the core cell walls 38. Each adhesive layer 17 is reticulated onto honeycomb core 19 to provide not only for improved bonding of the core to the combined elements 16 that now act as the sandwich skins, but to not fill or block the combined holes or openings 28. Although the present invention is generally described as being implemented using a honeycomb core, in alternate embodiments the honeycomb core can be eliminated entirely. Only the skin 16 with local stiffeners is utilized to form a laminate. The stiffened laminate is a combination of the reflective layer 54 and the tri-axial woven fabric layer 24 which can form a somewhat flexible structure that can be bent into a U-shape, or other shapes or rolled up, and restrained into a smaller volume and then when unrestrained in space it will unfurl and deploy into the larger final reflector structure. This allows the reflector to be flexible enough to be bent into a shape that will fit onto the satellite and also fit into the space provided in the rocket fairing that holds the satellite during launch. Once in orbit the restraining means is undone and the reflector returns to its unrestrained shape.

The two-layer skin combination 16 of FIG. 4 results in a material that is highly reflective of the Ka-Band and higher frequency microwave energy (which the tri-axial woven fabric material by itself is not) and still has holes and openness to allow the acoustic noise to pass. The tri-axial woven fabric layer 24 of FIG. 6, alone, is not able to reflect microwave frequencies at Ka-Band and higher frequencies with acceptable performance. That limitation is overcome by adding the conductive mesh layer 54 over the tri-axial woven fabric layer 24 of the reflectors 10 as shown in FIGS. 3 and 7. This new and improved two-layer combination containing the microwave reflective surface mesh layer 54 results in only a small addition of mass and only a slight difference in thermal distortion characteristics and still retains all the structural properties of the tri-axial woven fabric material 24 and its ability to transmit and dissipate acoustic energy.

By adding a more electrically conductive and electrically reflective layer 24 to the outer surface of the tri-axial woven fabric layer 26 used for the Ku-Band and lower frequency reflector design, the antenna reflector 10 can now be used at Ka-Band and higher frequencies. For example, in one embodiment, this layer 54 can be added to the graphite tri-axial woven fabric material of the current reflector of U.S. Pat. No. 5,686,930, to permit the use of this reflector at higher frequencies. This modification can be made without compromising the space worthiness of the already space qualified Ku-Band and lower frequency reflector, thereby avoiding the time and expense of having to perform extensive qualification testing of an entirely new Ka-Band reflector design.

In another embodiment, layer 54 can also be combined with a tri-axial woven fabric material consisting of a non-conductive dielectric polymer fiber. This would produce a new type of antenna reflector that would have very good electrical reflectivity properties at Ka-Band and at lower and higher frequencies and would also be lightweight and thermally stable.

Referring to FIG. 3, in one embodiment, the surface mesh layer 54 can be applied to the tri-axial woven fabric material 24 before the tri-axial woven fabric material is cut into the patterns that will be used to form the shape of the tri-axial woven fabric material 24 on the layup mold. This application of the surface mesh 54 to the tri-axial woven fabric prepeg 24 can be assisted by vacuum bag pressure. In this way the surface mesh material 54 adheres to the polymer resin in the tri-axial woven fabric prepreg and becomes attached to the tri-axial woven fabric prepreg. The tri-axial woven fabric prepreg gore patterns (with the surface mesh material 54 applied) are then placed on the reflector layup mold using hand layup techniques and a conventional prior art curing process for the tri-axial woven fabric prepreg material. A vacuum bag and an oven or autoclave can be utilized for curing in order to provide the heat and pressure that is required to rigidize the polymer resin and form the laminate or sandwich skin.

The surface microwave reflective mesh layer 54 could also be bonded using an adhesive such as an epoxy adhesive, to the cured and rigid reflector skin 16 or sandwich shell 26. Alternatively, the surface microwave reflective mesh 54 can be applied directly to the layup mold by vacuum forming it onto and to the shape of the mold by using a piece of polymeric film, for example, like nylon, over the mesh, which is then vacuum formed using a vacuum bag over the mold forming the mesh to the contour of the mold along with the film. After forming, the polymeric film is remove. The conductive mesh 54 holds the required shape of the mold. The graphite tri-axial woven fabric material 24 in prepreg form is then applied to the conductive mesh 54 while it is still in contact with the mold. The mesh material of the embodiments are easily formable to the typical slight contours of the reflector layup mold, because all of these mesh materials have a high enough elongation to yield ratio when formed.

A special bleeder material can be used to prevent the polymer resin in the tri-axial woven fabric material 24 in prepreg form from filling up the holes with resin in both the first surface mesh 54 and the tri-axial woven fabric material 24. The resin is absorbed by the bleeder material using a conventional polyester peel ply material such as Release Ply C which is a corona treated polyester woven fabric supplied by Airtech International Inc. of Huntington Beach, Calif.

The graphite composite tri-axial woven fabric laminate or skin 16 of a sandwich 26 is the structural load-carrying element of the structure. The microwave reflective mesh layer 54 is a non-structural electrically reflective layer only. The combination of the two materials into a two-layer construction 16 that becomes part of the sandwich 26 provides for both structural and electrical characteristics of the antenna reflector member assembly 10.

Dimensional stability in orbit is an issue for most antenna reflector designs, and near-zero coefficient of thermal expansion materials such as graphite fiber materials are usually used. The addition and presence of the mesh material 54 should not have a significant effect on the low CTE of the tri-axial woven fabric material 24. This is because the high Young's modulus of the graphite tri-axial woven fabric material 24 will dominate over the mesh layer 54 even though the mesh layer 54 may have a higher CTE, and the overall CTE of the combined laminate or skin 16 of the sandwich 26 will not be increased significantly.

By adding the mesh layer 54 to the front skin 16 of the sandwich 26, the sandwich would be unbalanced if the same mesh layer 54 was not added to the back skin. Not adding the mesh layer 54 to the back skin tri-axial woven fabric layer may be acceptable for some designs. However, most applications would require not only a balanced sandwich having the mesh layer 54 also on the back skin but it would be on the outer surface of the back skin to provide symmetry with the front skin 16 of the sandwich 26.

In one embodiment, the layer 54 can comprise an expanded metal foil material called Astrostrike that is supplied by Astroseal Products Manufacturing Co., Inc. of Old Saybrook, Conn. This foil is a nonwoven metallic mesh screen with a high percent of open area and with the holes 55 having a diamond shape. The lightest weight copper Astrostrike material, with a product designation of CU 015 CX, is preferred because it has a weight of 0.015 lbs./sq. ft. (or 74 gsm) and also has a percent open area of 89%. An aluminum Astrostrike material with a product designation of AL 016 CX is also a lightweight mesh screen material 0.016 lbs./sq. ft. (or 78 gsm) and may be used for some applications.

Another embodiment employs a layer 54 formed from a trico knitted fabric utilizing a prior art gold plated molybdenum wire. Other wires of copper, aluminum, silver, gold or gold plated beryllium copper could be used. The knitted mesh can be supplied by Fabric Development Inc. of Quakertown, Pa. and is knitted on a conventional prior art warp-knitting machine. Another fiber that can be knit or woven into a fabric mesh material is an electrically conductive plastic material with the trade name of Aracon manufactured by DuPont. A knit fabric of this material has been patented by Reynolds, et. al. in U.S. Pat. No. 5,885,906 LOW PIM REFLECTOR MATERIAL.

Another embodiment employs a layer 54 comprising a woven fabric screen mesh using aluminum or copper wire. A number of different wire screen mesh materials are available from Sefar a weaving enterprise based in Ruschlikon (Zurich) Switzerland with a U.S. distribution company, Sefar America, Inc. of Briarcliff Manor, N.Y. A 100×100 mesh size, or smaller mesh size (having larger holes), can be used.

The present invention generally comprises a microwave reflector for reflecting microwaves emitted and received by a microwave antenna while operating on a spacecraft in space. The microwave reflector has a first layer of an electrically conductive and electrically reflective mesh material that has holes or open areas. This reflective layer would be attached, via for example, bonding or molding to a tri-axial woven fabric layer. The other layer would be the structural tri-axial woven fabric layer that also has holes because of the weave pattern of the three oriented fibers making up the tri-axial woven fabric formed within the weave. It is the intersection of three graphite fibers oriented tri-axially to one another that make up the tri-axial woven fabric material. The microwave reflective layer is superior to the microwave reflectivity of the tri-axial woven fabric material by itself, and its addition on the surface of the tri-axial woven fabric is able to increase the operating microwave reflector capability up to Ka-Band and higher microwave frequencies. The holes or openings in the first layer would be large enough to allow acoustic noise to be transmitted and dissipated through these holes and also then transmitted and dissipated through the holes in the tri-axial woven fabric second layer making up the front skin and finally through the core and a back skin having a construction similar to the front skin. The high levels of acoustic noise produced during launch of the spacecraft can result in high structural loading of lightweight antenna reflector structures, and has been a major problem in the past. Holes in both the microwave reflective layer along with the holes in the tri-axial woven fabric second layer are desirable, because the acoustic noise that is produced during launch of the reflector on a spacecraft into space and during maneuvers in space are transmitted and dissipated through the holes in the two layers without causing structural damage or failure that would affect the ability of the reflector to reflect microwaves. It will continue to be a problem with thin and lightweight space structures having large unstiffened surface areas, with this acoustic noise environment sometimes resulting in structural failures of the reflector and its materials.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An antenna reflector for a spacecraft comprising:
at least one outer layer of an electrically conductive and electrically reflective material including a plurality of openings formed therein; and
at least one inner layer of a fabric material bonded to the outer layer, the fabric material including a plurality of openings formed therein, wherein a combination of the openings in the outer layer and the openings in the inner layer allow acoustic noise to be transmitted and dissipated through the openings.

2. The antenna reflector of claim 1, wherein the fabric material is a tri-axial woven fabric having three-fibers oriented tri-axially in three directions to each other.

3. The antenna reflector of claim 1 wherein the antenna is adapted to operate in a frequency band for Ka-Band or higher microwave frequencies.

4. The antenna reflector of claim 1 wherein the openings in the outer layer are aligned with the openings in the inner layer to maximize an amount of acoustic noise transmitted and dissipated through the antenna reflector.

5. The antenna reflector of claim 1 wherein the outer layer comprises a single ply multi-axial material.

6. The antenna reflector of claim 1 wherein the outer layer is a microwave reflective layer.

7. The antenna reflector of claim 1 further comprising a honeycomb sandwich structure having a combination of the inner layer and the outer layer bonded to each respective side of the sandwich structure.

8. The antenna reflector of claim 1 wherein one combination of the at least one layer of the electrically conductive and electrically reflective material and inner layer of fabric material is bonded to one side of a honeycomb core and another combination of the at leas one layer of the electrically conductive and electrically reflective material and inner layer of fabric material is bonded to an opposing side of the honeycomb core.

9. The antenna reflector of claim 1 wherein the fabric material is formed of aluminum or copper wires.

10. The antenna reflector of claim 1 wherein the electrically conductive and electrically reflective material is a wire mesh.

11. The antenna reflector of claim 1 wherein the outer layer and inner layer are adapted to form a flexible structure that can be shaped to be restrained in a smaller volume and unfurl when unrestrained.

12. The antenna reflector of claim 1 wherein elements making up the electrically conductive and electrically reflective material are smaller in diameter than fibers of the fabric material.

13. A method of forming a reflector membrane for an antenna reflector for a spacecraft comprising:
forming at least one outer layer of an electrically conductive and electrically reflective material including a plurality of openings formed therein;
at least one inner layer of a fabric material, the fabric material including a plurality of openings formed therein;
aligning the openings of the outer layer with the openings of the inner layer to form a plurality of combined openings in the reflector membrane, the combined openings adapted to allow acoustic noise transmission and dissipation through to combined openings, wherein the reflector membrane is adapted to operate in at least a microwave frequency band; and
bonding the outer layer to the inner layer.

14. The method of claim 13 wherein the outer layer is a microwave reflective mesh layer and the inner layer is a tri-axial woven fabric formed from three fibers oriented tri-axially in three directions to one another.

15. An antenna reflector structure for reflecting microwaves emitted and received by a microwave antenna while operating in space comprising:
in combination, the elements of a first surface microwave reflective mesh layer affixed to a second tri-axial woven fabric structural layer, the second layer having holes formed within the fabric by the intersection of three fibers oriented tri-axially in three directions to one another, wherein the first microwave reflective layer is a mesh having holes or openings that are large enough to allow acoustic noise waves produced during launch of the antenna on a spacecraft into space to be transmitted through the holes in the reflective mesh layer and through the holes that exist in the second tri-axial woven fabric layer, but the holes in the first microwave reflective mesh layer are small enough to still reflect the microwaves.

16. The antenna reflector structure according to claim 15 wherein the first surface microwave reflective mesh layer is metallic.

17. The antenna reflector structure according to claim 15 wherein the tri-axial fabric comprises high strength, high modulus fibers embedded within a cured resin polymer.

18. The antenna reflector structure according to claim 15 wherein the first microwave reflective mesh layer reflects microwaves at Ka-Band and higher microwave frequencies.

19. The antenna reflector structure according to claim 15 wherein the microwave reflective mesh layer is molded and bonded to the tri-axial fabric layer in a single manufacturing process.

20. The antenna reflector structure according to claim 15 wherein the combined layers of the first surface microwave reflective mesh layer and second woven fabric structural layer comprises the two skins of a sandwich shell construction.
